(19) United States
(12) Patent Application Publication
(10) Pub. No.: US 2025/0254513 A1
(43) Pub. Date: Aug. 7, 2025

(54) METHOD FOR DETERMINING TIMING FOR REQUESTING MUSIM GAPS

(71) Applicant: Samsung Electronics Co., Ltd., Gyeonggi-do (KR)

(72) Inventors: Aby Kanneath ABRAHAM, Bangalore (IN); Sangyeob JUNG, Gyeonggi-do (KR)

(21) Appl. No.: 18/854,749

(22) PCT Filed: Apr. 6, 2023
(86) PCT No.: PCT/KR2023/004683

§ 371 Date: Oct. 7, 2024

(30) Foreign Application Priority Data
Apr. 7, 2022 (IN) 202241021019
Mar. 28, 2023 (IN) 202241021019

(51) Int. Cl. H04W 8/18; H04L 1/1607; H04W 76/15

(52) U.S. Cl. CPC H04W 8/183; H04L 1/1642; H04W 76/15

(57) ABSTRACT

The disclosure relates to a 5G or 6G communication system for supporting a higher data transmission rate. The present subject matter refers to methods and systems for implementing a MUSIM gap.

### TECHNICAL FIELD

The present disclosure relates to method and system for implementing a Multi Subscriber Identity Module (MUSIM) gap.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### DISCLOSURE OF INVENTION

### Technical Problem

The operation of a MUSIM UE involves multiple USIMs sharing the same Radio Frequency (RF) circuitry in order to perform various activities and services on different networks. That implies, multiple USIMs need to arbitrate and share common RF resources among themselves to perform various network activities and/or avail network services. To perform network operations of USIM-B, the USIM-A may require a network gap (interchangeably referred as “MUSIM gap”) to avoid conflict of signals and resource usage. The present disclosure provides a method and an apparatus for deriving a timing for requesting and configuring MUSIM gaps.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

According to one embodiment of the present disclosure, a method for implementing a Multi Subscriber Identity Module (MUSIM) gap during carrier aggregation (CA) is disclosed. The method includes establishing, by a first Universal SIM (USIM) of a MUSIM User Equipment (UE), a connection with two or more Component Carriers (CCs) that is provided by one or more cells of a first network. The one or more cells of the first network includes at least one of a primary cell and a secondary cell. The method further includes determining, by the MUSIM UE, a requirement for a MUSIM gap in the first network for performing one or more network operations in a second USIM. Moreover, the method includes calculating, by the MUSIM UE, a timing of the MUSIM gap with respect to a timing configuration of the primary cell of the first network. Moreover, the method includes generating, by the MUSIM UE, a MUSIM gap request for the MUSIM gap based on the calculated timing for the MUSIM gap. Further, the method includes transmitting, to the first network, the generated MUSIM gap request.

According to another embodiment of the present disclosure, a method for implementing a MUSIM gap in dual connectivity scenarios at a MUSIM UE is disclosed. The method includes establishing, by a first Universal SIM (USIM) of the MUSIM UE, dual connectivity with at least one of a primary network node and a secondary network node. The method also includes receiving, from the primary network node, a timing configuration information for calculating a timing for a MUSIM gap. Further, the method includes determining, by the UE, a requirement for the MUSIM gap in the first USIM connection for performing one or more operations in the second USIM. Moreover, the method includes calculating the timing for the required MUSIM gap based on the at least one of the received timing configuration information from the primary network node and the timing configuration information based on a predefined selection process in the UE. Also, the method includes generating a MUSIM gap request for the required MUSIM gap based on the calculated timing for the MUSIM gap. Further, the method includes transmitting, to the primary network node, the generated MUSIM gap request.

According to yet another embodiment of the present disclosure, a method for implementing a Multi Subscriber Identity Module (MUSIM) gap in dual connectivity scenarios at a base station is disclosed. The method includes establishing, with a first Universal SIM (USIM) of a MUSIM User Equipment (UE), dual connectivity with at least one of a primary network node and a secondary network node of the base station. The method also includes receiving an indication that the MUSIM UE supports configuration of a MUSIM gap for at least one of a second USIM. Further, the method includes transmitting, to the MUSIM UE, timing configuration information for calculating timing for the MUSIM gap based on the received indication, the timing configuration information includes at least one of an indication of a reference cell to be used for timing configuration, the System Frame Number (SFN), and subframe numbers. The reference cell is one of a primary cell of a Master Cell Group (MCG), a primary cell of a Secondary Cell Group (SCG), or a Frequency Range 2 (FR2) cell in the MCG.

According to yet another embodiment of the present disclosure, a system for implementing a Multi Subscriber Identity Module (MUSIM) gap in carrier aggregation scenarios is disclosed. The system includes a memory and at least one processor communicably coupled to the memory. The at least one processor is configured to establish, using a first Universal SIM (USIM) of a MUSIM User Equipment (UE), a connection with two or more Component Carriers (CCs) that is provided by one or more cells of a first network. The one or more cells of the first network includes at least one of a primary cell and a secondary cell. Further, the at least one processor is configured to determine a requirement for a MUSIM gap in the first network for performing one or more network operations in the second USIM. Moreover, the at least one processor is configured to calculate the timing of the MUSIM gap with respect to a timing configuration of the primary cell of the first network. The at least one processor is also configured to generate a MUSIM gap request for the MUSIM gap based on the calculated timing for the MUSIM gap. Further, the at least one processor is configured to transmit, to the first network, the generated MUSIM gap request.

According to yet another embodiment of the present disclosure, a system for implementing a Multi Subscriber Identity Module (MUSIM) gap in dual connectivity scenarios at a MUSIM User Equipment (UE) is disclosed. The system includes a memory and at least one processor communicably coupled to the memory. The at least one processor is configured to establish, using a first Universal SIM (USIM) of the MUSIM UE, dual connectivity with at least one of a primary network node and a secondary network node. The at least one processor is also configured to receive, from the primary network node, a timing configuration information for calculating timing for a MUSIM gap. Moreover, the at least one processor is configured to determine a requirement for the MUSIM gap in the first USIM connection for performing one or more operations in the second USIM. Furthermore, the at least one processor is configured to calculate the timing for the required MUSIM gap based on the at least one of the received timing configuration information from the primary network node and the timing configuration information based on predefined selection process in the UE. Also, the al least one processor is configured to generate a MUSIM gap request for the required MUSIM gap based on the calculated timing for the MUSIM gap. Furthermore, the at least one processor is configured to transmit, to the primary network node, the generated MUSIM gap request.

According to yet another embodiment of the present disclosure, a system for implementing a Multi Subscriber Identity Module (MUSIM) gap in dual connectivity scenarios at a base station. The system includes a memory and at least one processor communicably coupled to the memory. The at least one processor is configured to establish, with a first Universal SIM (USIM) of a MUSIM User Equipment (UE), dual connectivity with at least one of a primary network node and a secondary network node of the base station. The at least one processor is also configured to receive an indication that the MUSIM UE supports configuration of a MUSIM gap for at least one of a second USIM. The at least one processor is also configured to transmit, to the MUSIM UE, timing configuration information for calculating timing for the MUSIM gap based on the received indication. The timing configuration information includes at least one of an indication of a reference cell to be used for timing configuration, the SFN, and subframe numbers. The reference cell is one of a primary cell of a Master Cell Group (MCG), a primary cell of a Secondary Cell Group (SCG), or a Frequency Range 2 (FR2) cell in the MCG.

To further clarify the advantages and features of the present invention, a more particular description of the invention will be rendered by reference to specific embodiments thereof, which is illustrated in the appended drawing. It is appreciated that these drawings depict only typical embodiments of the invention and are therefore not to be considered limiting its scope. The invention will be described and explained with additional specificity and detail with the accompanying drawings.

### Advantageous Effects of Invention

The present disclosure provides an effective and efficient solution to implement MUSIM gaps. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary environment of Multi Universal Subscriber Identify Module (MUSIM) user Equipment (UE), according to an embodiment of the present disclosure;

FIG. 2 illustrates an exemplary process flow depicting a method for implementing a MUSIM gap during Carrier Aggregation (CA), according to an embodiment of the present disclosure;

FIG. 3 illustrates an exemplary process flow depicting a method for implementing a MUSIM gap in dual connectivity scenarios at a UE, according to an embodiment of the present disclosure;

FIG. 4 illustrates an exemplary process flow depicting a method for implementing a MUSIM gap in dual connectivity scenarios at a base station, according to an embodiment of the present disclosure;

FIG. 5 illustrates an operational flow diagram depicting a process for determining a timing for requesting MUSIM gaps, in accordance with an embodiment of the present subject matter;

FIG. 6 illustrates an operational flow diagram depicting a process for deriving System Frame Number (SFN)/subframe for the UE to request MUSIM gap when dual connectivity is configured, in accordance with an embodiment of the present subject matter;

FIG. 7 illustrates an operational flow diagram depicting a process for deriving System Frame Number (SFN)/subframe for the UE to request MUSIM gap when dual connectivity is configured, in accordance with another embodiment of the present subject matter;

FIG. 8 is a diagram illustrating the configuration of a UE in a wireless communication system, according to an embodiment of the present disclosure; and

FIG. 9 is a diagram illustrating the configuration of a base station in a wireless communication system, according to an embodiment of the present disclosure.

Further, skilled artisans will appreciate that elements in the drawings are illustrated for simplicity and may not have been necessarily drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art.

Embodiments of the present invention will be described below in detail with reference to the accompanying drawings.

Multi Universal Subscriber Identity Module (USIM) User Equipment (UE) refers to a device that is capable of supporting multiple USIMs simultaneously. Particularly, the MUSIM UE is capable of hosting more than one USIM to establish connection with two or more different networks. Such device allows a user to have different connection plans, different profiles, increased connectivity/reliability with the support of multiple network connection.

However, in order to save on cost, the operation of a MUSIM UE involves multiple USIMs sharing the same Radio Frequency (RF) circuitry in order to perform various activities and services on different networks. That implies, multiple USIMs need to arbitrate and share common RF resources among themselves to perform various network activities and/or avail network services. Example of such network services include paging reception, system information block (SIB) acquisition, measurement, data or voice call, Multimedia Broadcast Multicast Service (MBMS), emergency call, Access Stratum (AS) signaling, Non-Access Stratum (NAS) signaling, and so forth.

Prior to Release 17 in 3GPP, the MUSIM UEs were performing MUSIM operations using arbitrary gaps without any control by the network. From Release 17, a USIM connected to a network node is configured to notify the connected network node about the network switching required for MUSIM operations and required gaps for MUSIM operations. Moreover, in Release 17, MUSIM UE uses RRC UE Assistance Information (UAI) procedure to request the network node (gNB) for MUSIM gaps or to notify the network node regarding the network switching. In release 17, only per-UE gaps are supported for MUSIM operations.

In release 17, MUSIM UE uses RRC UE Assistance Information (UAI) procedure to request gNB for gaps or to notify gNB about leaving. Network (gNB) configures the UE whether it can provide the assistance information for MUSIM gaps or MUSIM Leave using otherConfig in RRC messages. Musim-GapAssistanceConfig in otherConfig is used for informing UE whether it can provide MUSIM assistance information for providing gap information. In release 17, only per-UE gaps are supported for MUSIM operations.

Below is the extract for NR RRC specification on how otherConfig including musimGapAssistanceConfig is used.

if the received otherConfig includes the musim-GapAssistanceConfig:
if musim-GapAssistanceConfig is set to setup:
consider itself to be configured to provide MUSIM assistance information without leaving
RRC_CONNECTED in accordance with 5.7.4;
2> else:
3> consider itself not to be configured to provide MUSIM assistance information without
leaving RRC_CONNECTED in accordance with 5.7.4 and stop timer T3yy, if running;

Below is the extract for NR RRC specification on the definition of otherConfig including musim-GapAssistanceConfig.

| RRCReconfiguration-v17xy-IEs ::= | SEQUENCE { | |
|---|---|---|
| otherConfig-v17xy | OtherConfig-v17xy | OPTIONAL, |

-- Need M

| | |
|---|---|
| musim-GapConfig-r17 | SetupRelease {MUSIM-GapConfig-r17} |

OPTIONAL, -- Need M

| | | |
|---|---|---|
| nonCriticalExtension | SEQUENCE { } | OPTIONAL |

}

| | |
|---|---|
| OtherConfig-v17xy ::= | SEQUENCE { |
| musim-GapAssistanceConfig-r17 | SetupRelease {MUSIM-GapAssistanceConfig-r17} |

OPTIONAL, -- Need M

| | |
|---|---|
| musim-LeaveAssistanceConfig-r17 | SetupRelease {MUSIM-LeaveAssistanceConfig- |

r17} OPTIONAL -- Need M
}

| | |
|---|---|
| MUSIM-GapAssistanceConfig-r17 ::= | SEQUENCE { |
| musim-GapProhibitTimer-r17 | ENUMERATED {s0, s0dot1, s0dot2, s0dot3, s0dot4, |

s0dot5, s1, s2, s3, s4, s5, s6, s7, s8, s9, s10}
}

musim-GapAssistanceConfig communicated by gNB to UE in the present NR specification (Initial version of TS 38.331 specification) contains only musimGapProhibitTimer which is the prohibit timer for MUSIM assistance information reporting without leaving RRC_CONNECTED for MUSIM purpose.

Once configured MUSIM UE (connected USIM) requests for gaps for MUSIM purpose by sending UE Assistance Information as in the below extracts from 3gpp TS 38.331 specification.

A UE capable of providing MUSIM assistance information may
initiate the procedure if it was configured to do so, upon
determining that it needs to leave RRC_CONNECTED state, or
upon determining it needs the gaps, or upon change of the
gap information without leaving RRC_CONNECTED state.
if configured to provide MUSIM assistance information without
leaving RRC_CONNECTED:
if the UE has a preference on the MUSIM gap(s) and the UE did
not transmit a UEAssistanceInformation message with musim-
GapPreferenceList since it was configured to provide MUSIM
assistance information without leaving RRC_CONNECTED; or
if the current musim-GapPreferenceList is different from the
one indicated in the last transmission of the UEAssistance-
Information message including musim- GapPreferenceList and
the timer T3yy is not running:
initiate transmission of the UEAssistanceInformation message
in accordance with 5.7.4.3 to provide the current musim-
GapPreferenceList;
3> start the timer T3yy with the timer value set to the musim-
GapProhibitTimer.

if transmission of the UEAssistanceInformation message is
initiated to provide MUSIM assistance information according
to 5.7.4.2 or 5.3.5.3:
if the UE has a preference for MUSIM periodic gap(s):
include musim-GapPreferenceList, with an entry for each
periodic gap the UE prefers to be configured;
set musim-Gaplength and musim-GapRepetitionAndOffset in
the musim-GapInfo IE to the values of the length and the
repetition/offset of the gap(s), respectively, the UE
prefers to be configured with;
2> if the UE has a preference for MUSIM aperiodic gap:
include the field musim-GapPreferenceList, with one entry
for the aperiodic gap the UE prefers to be configured;
set musim-Gaplength and musim-Starting-SFN-AndSubframe in
the musim-GapInfo IE to the values of respectively the
length and the starting SFN/subframe of the gap,
respectively, the UE prefers to be configured with;
2> else (if the UE has no longer preference for the
periodic/aperiodic gaps):
3>do not include musim-GapPreferenceList in the musim-
Assistance IE;

UE uses MUSIM assistance Information for both periodic and aperiodic gaps. For periodic gaps, assistance information includes gap repetition period and gap offset. For aperiodic gaps which are one-time gaps, UE provides starting SFN and Subframe required for the gap.

The below extract includes the definition and description of MUSIM gap information requested by the connected UE to the connected network in UE Assistance Information.

| | |
|---|---|
| MUSIM-Assistance-r17 ::= | SEQUENCE { |

| | |
|---|---|
| musim-PreferredRRC-State-r17 | ENUMERATED {IDLE, INACTIVE, |

| | |
|---|---|
| outOfConnected} | OPTIONAL, |

| | |
|---|---|
| musim-GapPreferenceList-r17 | MUSIM-GapPreferenceList-r17 |

OPTIONAL,
...
}
MUSIM-GapPreferenceList-r17 := SEQUENCE (SIZE (1..3)) OF MUSIM-GapInfo-r17

| | |
|---|---|
| MUSIM-GapInfo-r17 ::= | SEQUENCE { |

| | |
|---|---|
| musim-Starting-SFN-AndSubframe-r17 | MUSIM-Starting-SFN-AndSubframe-r17 |

OPTIONAL,

| | |
|---|---|
| musim-GapLength-r17 | ENUMERATED {ms43, ms4, ms6, ms10, ms20}, |
| musim-GapRepetitionAndOffset-r17 | CHOICE { |
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms1280-r17 | INTEGER (0..1279), |
| ms2560-r17 | INTEGER (0..2559), |
| ms5120-r17 | INTEGER (0..5119), |

...
} OPTIONAL
}

| | |
|---|---|
| MUSIM-Starting-SFN-AndSubframe-r17 ::= | SEQUENCE { |

| | |
|---|---|
| starting-SFN-r17 | INTEGER (0..1023), |
| startingSubframe-r17 | INTEGER (0..9) |

}

musim-GapLength
Indicates the length of the UE's preferred MUSIM gap length.
musim-GapOffset
Indicates the gap offset of the UE's preferred MUSIM gap.
musim-GapPreferenceList
Indicates the MUSIM gap(s) that the UE prefers to be configured with.
musim-GapRepetitionAndOffsetPeriod
Indicates the gap repetition period and gap offset of the UE's
preferred periodic MUSIM gap without leaving RRC_CONNECTED
state. This field is only used for periodic gaps.
musim-Starting-SFN-AndSubframe
Indicates gap starting position offor UE's preferred aperiodic
MUSIM gap without leaving RRC_CONNECTED state

Once the network receives the UE Assistance Information indicating gap preference for MUSIM operation, it may configure the UE with MUSIM gaps.

An extract of RRC specifications which indicates UE behavior while receiving RRC Reconfiguration with gap configuration is given below.

if the RRCReconfiguration message includes the musim-GapConfig:
for each periodic musim-GapID included in the received musim-GapToReleaseList:
release the MUSIM periodic gap associated to the musim-GapID from the musim-
GapConfigList;
2> for each periodic musim-GapID included in the received musim-GapToAddModList:
if an entry with the matching musim-GapID exists in the musim-GapConfigList:
replace the entry with the value received for this musim-GapID;
3> else:
4> add a new entry for this musim-GapID;

An extract of RRC specifications including the definition of GapConfiguration is given below.

```
    MUSIM-GapConfig
The IE MUSIM-GapConfig specifies the MUSIM gap configuration and controls
setup/release of MUSIM gaps.
MUSIM-GapConfig information element
  ASN1START
  TAG-MUSIM-GAPCONFIG-START
```

| | |
|---|---|
| MUSIM-GapConfig-r17 ::= | SEQUENCE { |
| musim-GapToReleaseList-r17 | SEQUENCE (SIZE (1..2)) OF MUSIM-GapID-r17 |

OPTIONAL,

| | |
|---|---|
| musim-GapToAddModList-r17 | SEQUENCE (SIZE (1..2)) OF MUSIM-GapInfo- |

r17 OPTIONAL,

| | | |
|---|---|---|
| musim-AperiodicGap-r17 | MUSIM-GapInfo-r17 | OPTIONAL, -- Need |

N
...
}

| MUSIM-GapInfo-r17 ::= | SEQUENCE { | |
|---|---|---|
| musim-GapID-117 | MUSIM-GapID-r17 | OPTIONAL, - Cond periodic |

| | |
|---|---|
| musim-Starting-SFN-AndSubframe-r17 | MUSIM-Starting-SFN-AndSubframe-r17 |

OPTIONAL, -- Cond aperiodic

| | |
|---|---|
| musim-GapLength-r17 | ENUMERATED {ms3, ms4, ms6, ms10, ms20} |

OPTIONAL,

| | |
|---|---|
| musim-GapRepetitionAndOffset-r17 | CHOICE { |

| | |
|---|---|
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms1280-r17 | INTEGER (0..1279), |
| ms2560-r17 | INTEGER (0..2559), |
| ms5120-17 | INTEGER (0..5119), |

...
} OPTIONAL -- Cond periodic
}

| | |
|---|---|
| MUSIM-Starting-SFN-AndSubframe-r17 ::= | SEQUENCE { |

| | |
|---|---|
| starting-SFN-r17 | INTEGER (0..1023), |
| startingSubframe-r17 | INTEGER (0..9) |

}
TAG-MUSIM-GAPCONFIG-STOP
-- ASN1STOP

Further 3gpp specification extract which includes the definition of various fields above is given below.

musim-AperiodicGap
Indicate that the UE is allowed to use the MUSIM aperiodic gap if
requested in the UEAssistanceInformation.
musim-GapRepetition AndOffset
Indicates the gap repetition period in ms and gap offset in number
of subframes for the periodic MUSIM gap without leaving
RRC_CONNECTED state.
musim-Start-SFN-AndSubframe
Indicates gap starting position for the aperiodic MUSIM gap without
leaving RRC_CONNECTED state. This field is only used for aperiodic
gap.
musim-Gap ToAddModList
List of MUSIM periodic gap pattern identities to add or modify
without leaving RRC_CONNECTED state.
musim-GapToReleaseList
List of MUSIM periodic gap pattern identities to release without
leaving RRC_CONNECTED state.
Indicates gap starting position offor UE's preferred aperiodic
MUSIM gap without leaving RRC_CONNECTED state

MUSIM gap configuration to the UE contains musim-Start-SFN-AndSubframe for aperiodic gaps and musim-GapRepetitionAndOffset for periodic gaps. However, such processes fail to effective and efficient implement MUSIM operations in complex network scenarios such as, carrier aggregation or dual connectivity. In order to overcome above-mentioned problems in the mobile communication network, there is a need to provide a technique to enable the MUSIM operations in an effective and efficient manner.

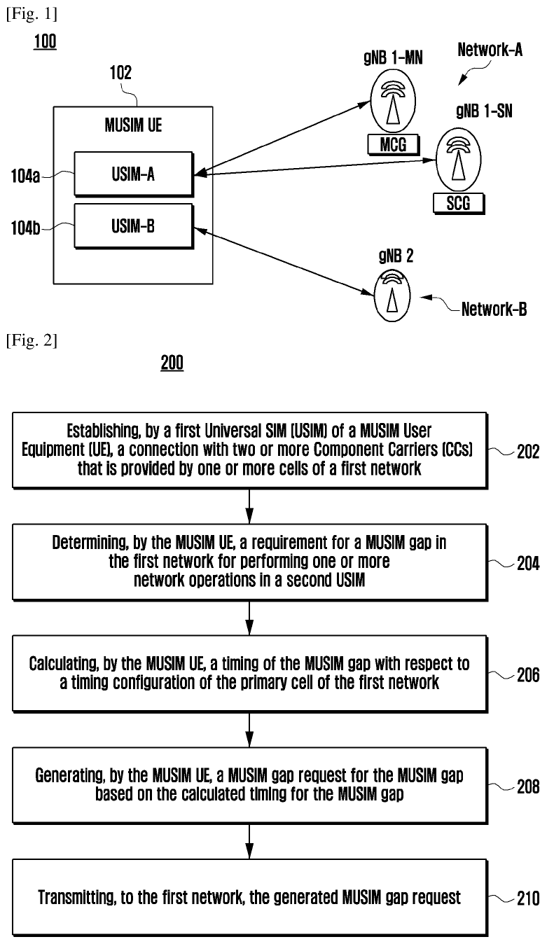

FIG. 1 illustrates an exemplary environment 100 of Multi Universal Subscriber Identify Module (MUSIM) user Equipment (UE) 102, according to an embodiment of the present disclosure. The MUSIM UE 102 may be configured to connect to one or more networks using two or more USIMs. In an illustrated embodiment, the MUSIM UE 102 (interchangeably referred as “the UE 102”) includes two USIMs i.e., USIM-A 104a, and USIM-B 104b to connect to one or more networks. However, embodiments intent to include or otherwise cover any number of USIMs configured at the UE 102. Example of UE 102 may include, but not limited to, a mobile phone, a laptop computer, a desktop computer, a Personal Computer (PC), a notebook, a tablet, or any other suitable communication device configured to support MUSIM operations.

The UE 102 may include any suitable combination of hardware and software components which may be required to support the MUSIM operations. A description of such component has been omitted for the sake of brevity. In an exemplary embodiment, the USIM-A 104a may be connected to a network-A including a plurality of cells. The network-A may include a Main Node (MN) configured with a base station (gNB1-MN) and a Secondary Node (SN) configured with a base station (gNB1-SN). The MN of the network-A may include a Master Cell Group (MCG) and the SN of the network-A may include a Secondary Cell Group (SCG) configured to support the network operations of the USIMs installed at the UE 102. Further, the illustrated network nodes or the cell groups are exemplary in nature, and the network may include any number of network nodes or the cell groups. Moreover, multiple network nodes or the cell groups may enable the network to support complex network scenarios such as Carrier Aggregation (CA) or dual connectivity. In an embodiment, the USIM-B 104b may be camped to a network-B configured with base station (gNB2). However, the USIM-B 104b may remain in idle state during the network operations of the USIM-A 104a, as each of the USIM-B 104b and the USIM-A may utilize a single set of network components available at the UE 102.

Particularly, the UE 102 may include a single set of network components such as, but not limited to, antennas, transceivers, modulators-demodulators, amplifiers, and so forth. The single set of network components provides a cheaper, simpler, and compact network structure at the UE 102. Thus, to perform network operations of USIM-B, the USIM-A may require a network gap (interchangeably referred as “MUSIM gap”) to avoid conflict of signals and resource usage. Therefore, the present disclosure provides an effective and efficient solution to implement MUSIM gaps in different network scenarios such as, but not limited to, carrier aggregation and multi-radio dual connectivity scenario.

In Carrier Aggregation (CA), two or more Component Carriers (CCs) of the network may be aggregated. Specifically, in CA, the UE 102 may simultaneously receive or transmit on one or multiple CCs depending on capabilities of the UE. The CA may be supported for both contiguous and non-contiguous CCs. When the CA is deployed frame timing and System Frame Number (SFN) required to define MUSIM gap may be aligned across cells that can be aggregated (synchronous CA), or an offset in multiples of slots between the primary cell and secondary cell may be configured to be aggregation (Asynchronous CA). In an embodiment, the UE 102 in inactive mode may store CA configuration information. In CA, the primary cell may the cell that is used for initial access while other cells may be referred as secondary cells.

Dual connectivity or more technically multi-radio dual connectivity is specified by 3gpp in specifications such as TS 37.340. A summary of the details on dual connectivity are given below.

New Generation-Radio Access Network (NG-RAN) supports Multi-Radio Dual Connectivity (MR-DC) operation whereby a user equipment (UE) in Radio Resource Control-Connected (RRC_CONNECTED) state may be configured to utilize radio resources provided by two distinct schedulers, located in two different NG-RAN nodes connected via a non-ideal backhaul, one providing NR (New Radio) access and the other one providing either E-UTRA (Evolved UMTS Terrestrial Radio Access) or NR access. One node may act as the master/main node (MN) and the other as the secondary node (SN). The MN and SN are connected via a network interface and at least the MN is connected to the core network. NG-RAN supports NG-RAN EUTRA-NR Dual Connectivity (NGEN-DC), in which the UE 102 may be connected to one ng-eNB (a E-UTRA base station that can connect to 5G core) that acts as a MN and one gNB (5G base station) that acts as a SN. NG-RAN also supports NR-E-UTRA Dual Connectivity (NE-DC). Primary cell of a master or secondary cell group is called SpCell. SpCell of a master cell group may be referred as PCell while SpCell of a secondary cell group may be referred as PSCell. In MR-DC, a group of serving cells associated with the Master Node, comprising of the SpCell (PCell) and optionally one or more SCells is called MCG or Master Cell Group. A group of serving cells associated with the Secondary Node, comprising of the SpCell (PSCell) and optionally one or more SCells is known as Secondary Cell Group (SCG) in MR-DC. Further, the frame timing and SFN between the cells in MCG and SCG may not be aligned.

A connected USIM in MUSIM UE (USIM-A) may request gaps to its connected network (NWK-A) for the operations like paging monitoring, serving and neighboring measurements, cell reselection operations including reading the system information of the target cell for the idle/inactive UE (USIM-B). USIM-A may be configured with dual connectivity or carrier aggregation, while the USIM-B may have CA or DC configuration stored. USIM-A needs to provide the required timing, i.e. SFN and subframe for aperiodic gaps and offset for periodic gaps to NWK-A while requesting for the MUSIM gaps. We propose how the USIM-A derives the timing for requesting the MUSIM gaps for USIM-B's operations in MUSIM UE.

FIG. 2 illustrates an exemplary process flow depicting a method 200 for implementing a MUSIM gap during Carrier Aggregation (CA), according to an embodiment of the present disclosure. The method 300 may be performed by the UE 102, components of the network-A, and/or components of network-B, as shown in FIG. 1.

At step 202, the method 200 may include establishing, by the first Universal SIM (USIM-A) 104a of the MUSIM User Equipment (UE) 102, a connection with two or more Component Carriers (CCs) that is provided by one or more cells of the first network (network-A).

Next, at step 204, the method 200 may include, determining, by the MUSIM UE 102, a requirement for a MUSIM gap in the first network (network-A) for performing one or more network operations in the second USIM (USIM-B) 104b. In an embodiment, the UE 102 may determine the requirement for the MUSIM gap upon receiving an indication to perform the one or more network operations from USIM-B 104b. Such indication indicate may also indicate the requirement of one or more network resources of the UE 102 which may be in use by the USIM-A 104a for the network operations of the USIM-B 104b. Upon receipt of said indication, the UE 102 may determine that there is requirement for the MUSIM gap in order to perform network operations of both the USIM i.e., USIM-A 104a and the USIM-B 104b. In another embodiment, the UE 102 may determine a requirement for the MUSIM gap based at least on determining that the USIM-A 104a has performed the network operation for a predefined time period or the USIM-A has not performed any network operation for a predefined time period.

At step 206, the method 200 may include calculating, by the MUSIM UE 102, a timing of the MUSIM gap with respect to a timing configuration of the primary cell of the first network (network A). The timing configuration of the primary cell of the first network may include information such as, but not limited to, System Frame Number, subframe numbers, and so forth. Specifically, the network may define timing for MUSIM gap in terms of SFN and subframe numbers. Further, each of the primary cell and the secondary cell of the network may have different timing configuration. Thus, the timing configuration corresponding to the primary cell may include a current SFN and subframe number of the primary cell. In an embodiment, the UE 102 may determine the requirement of MUSIM gap timing based on the indication received from the USIM-B 104b and calculate and/or modify the MUSIM gap timing based on the timing information of the primary cell of the network-A.

At step 208, the method 200 may include generating, by the MUSIM UE 102, a MUSIM gap request for the MUSIM gap based on the calculated timing for the MUSIM gap. As the timing requirement for MUSIM gap is based on the timing configuration of the primary cell of the network A, the primary cell may be able to process the MUSIM gap in an effective and efficient manner. In an embodiment, the MUSIM gap corresponds to periodic MUSIM gap or aperiodic MUSIM gap. Further, in case of the periodic MUSIM gap, the generated MUSIM gap request may include information such as, but not limited to, a gap offset, a gap repetition, and a gap length based on calculated timing of the MUSIM gap. In case of the aperiodic MUSIM gap, the generated MUSIM gap request may include information such as, but not limited to, a starting System Frame Number (SFN), a subframe, and a gap length, based on the calculated timing of the MUSIM gap.

At step 210, the method 200 may include, transmitting, to the first network (network A) the generated MUSIM gap request. Further, the method 200 may include receiving, from the first network (network A) a MUSIM gap configuration based on the transmitted MUSIM gap request to configure the required MUSIM gap.

Embodiments are exemplary in nature and the steps of the method 200 as shown in FIG. 2 may occur in variations to the sequence in accordance with various embodiments. The variation may include addition and/or omission of steps illustrated in FIG. 2.

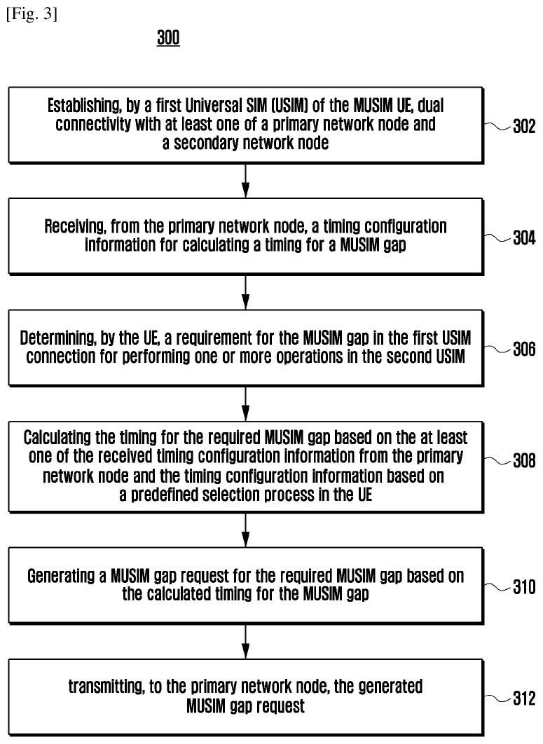

FIG. 3 illustrates an exemplary process flow depicting a method 300 for implementing a MUSIM gap in dual connectivity scenarios at the UE 102, according to an embodiment of the present disclosure. The method 300 may be implemented using the UE 102, components of the network-A, and/or components of network-B, as shown in FIG. 1.

At step 302, the method 300 may include establishing, by the first Universal SIM (USIM-A) 104a of the MUSIM UE 102, dual connectivity with at least one of a primary network node and a secondary network node of the network A. Next, at step 304, the method 300 may include receiving, from the primary network node, a timing configuration information for calculating a timing for a MUSIM gap. In an embodiment, the primary network node may determine that the connected UE 102 is a MUSIM UE that may require to MUSIM operation, therefore the primary network node may transit the timing configuration for calculation the timing for the MUSIM gap, if needed. In an embodiment, the primary network node may determine that the UE 104 is the MUSIM UE based on reception of an indication from the UE 102 or based on reception of multiple connection and/or network service requests from the UE 102.

At step 306, the method 300 may include determining, by the UE 102, a requirement for the MUSIM gap in the first USIM (USIM-A) 104a connection for performing one or more operations in the second USIM (USIM-B) 104b. In an embodiment, the UE 102 may determine the requirement for the MUSIM gap upon receiving an indication to perform the one or more network operations from USIM-B 104b. Such indication indicate may also indicate the requirement of one or more network resources of the UE 102 which may be in use by the USIM-A 104a for the network operations of the USIM-B 104b. Upon receipt of said indication, the UE 102 may determine that there is requirement for the MUSIM gap in order to perform network operations of both the USIM i.e., USIM-A 104a and the USIM-B 104b. In another embodiment, the UE 102 may determine a requirement for the MUSIM gap based at least on determining that the USIM-A 104a has performed the network operation for a predefined time period, or the USIM-A has not performed any network operation for a predefined time period.

At step 308, the method 300 may include calculating the timing for the required MUSIM gap based on the at least one of the received timing configuration information from the primary network node and the timing configuration information based on a predefined selection process in the UE. In an embodiment, the UE 102 may calculate the timing for the required MUSIM gap based on the timing configuration information from the primary network node. In an embodiment, the timing configuration from the primary network node may include information such as, but not limited to, an indication of the reference cell to be used for timing configuration, the SFN, and subframe numbers. Further, the reference cell may be one of the primary cell of a Master Cell Group (MCG), a primary cell of a Secondary Cell Group (SCG), or a Frequency Range 2 (FR2) cell in the MCG. In an embodiment, the predefined selection process which may be used by the UE 102 to receive the timing configuration for calculating the MUSIM gap may include selecting the primary cell of MCG as the reference cell when the MUSIM gap is applicable to at least one of MCG, SCG, perUE MUSIM gap, per-FR MUSIM gap for the FR of at least one serving cell in MC. The predefined selection process may also include selecting the primary cell of SCG when the MUSIMG gap is applicable to at least one of SCG, per-FR MUSIM gap for the FR configured in SCG.

At step 310, the method 300 may include generating a MUSIM gap request for the required MUSIM gap based on the calculated timing for the MUSIM gap. In an exemplary embodiment, the UE 102 may generate the MUSIM gap request based on the calculated timing. In an embodiment, the MUSIM gap may correspond periodic MUSIM gap or aperiodic MUSIM gap. Further, in case of the periodic MUSIM gap, the MUSIM gap request may include information such as, but not limited to, a gap offset calculated based on the reference cell and the indication of the reference cell. In case of the aperiodic MUSIM gap, the MUSIM gap request may include information, such as, but not limited to, a starting SFN and subframe calculated based on the reference cell, and the indication of the reference cell.

At step 312, the method 300 may include transmitting, to the primary network node, the generated MUSIM gap request. The UE 102 may transmit the generated MUSIM gap request to the primary network node and the network A. The method 300 may also include receiving, from the primary network node, MUSIM gap configuration based the transmitted MUSIM gap request to configure the MUSIM gap.

Embodiments are exemplary in nature and the steps of the method 300 as shown in FIG. 3 may occur in variations to the sequence in accordance with various embodiments. The variation may include addition and/or omission of steps illustrated in FIG. 3.

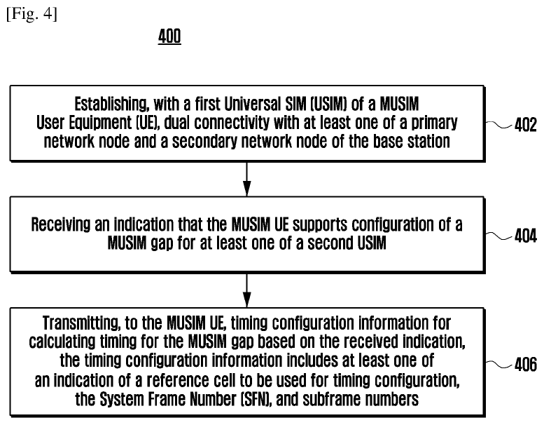

FIG. 4 illustrates an exemplary process flow depicting a method 400 for implementing a MUSIM gap in dual connectivity scenarios at a base station (gNB1), according to an embodiment of the present disclosure. The method 400 may be implemented using the UE 102, components of the network-A, and/or components of network-B, as shown in FIG. 1.

At step 402, the method 400 may include establishing, with a first Universal SIM (USIM-A) 104a of the MUSIM User Equipment (UE) 102, dual connectivity with at least one of a primary network node and a secondary network node of the base station. Next, at step 404, the method 400 may include receiving an indication that the MUSIM UE 102 supports configuration of a MUSIM gap for at least one of a second USIM (USIM-B) 104b. Lastly, at step 406, the method 400 may include transmitting, to the MUSIM UE 102, timing configuration information for calculating timing for the MUSIM gap based on the received indication. In an exemplary embodiment, the timing configuration may include information such as, but not limited to, an indication of a reference cell to be used for timing configuration, the System Frame Number (SFN), and subframe numbers.

Embodiments are exemplary in nature and the steps of the method 400 as shown in FIG. 4 may occur in variations to the sequence in accordance with various embodiments. The variation may include addition and/or omission of steps illustrated in FIG. 4.

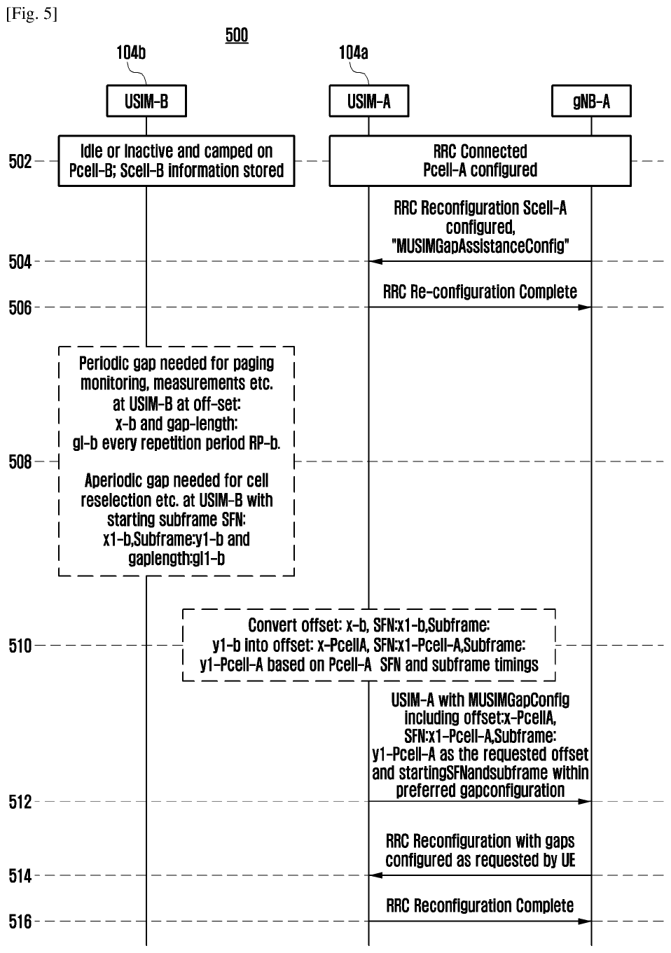

FIG. 5 illustrates an operational flow diagram depicting a process 500 for determining a timing for requesting MUSIM gaps for the MUSIM UE 102 in a carrier aggregation scenario, in accordance with an embodiment of the present subject matter. The process 500 may be implemented using the UE 102, components of the networkA, and/or components of network-B, as shown in FIG. 1.

In an embodiment, the MUSIM UE 102 may include two USIMs i.e., USIM-A 104a in a RRC-CONNECTED state with the network A and USIM-B 104b in a RRC_IDLE or RRC_INACTIVE state with the network B, as shown in step 502.

Further, step 502 indicates that the USIM-A 104a may be configured with carrier aggregation request which may include a starting SFN and subframe for aperiodic MUSIM gaps and the gap offset for periodic MUSIM gaps in reference to the SEN and subframe of the Primary Cell (PCell) of the network A. The staring SFN and subframe in the request may be referred as “musim-Start-SFN-AndSubframe” Further, the gap offset in the request may be referred as “musim-GapRepetitionAndOffset”

Further, embodiments explained above in reference to FIG. 2 may be illustrated below. For example,
a current SFN and subframe number of Primary Cell (PCell) in USIM-A (PCell-A) may be 100 and 5,
a current SFN and subframe number of Secondary cell (SCell) in USIM-A (SCell-A) may be 98 and 3,
a current SFN and subframe number of camped cell in USIM-B (PCell-B) may be 75 and 4, and
a current SFN and subframe number of stored Scell in USIM-B (SCell-B) may be 78 and 3.

Further, the USIM-B requires an aperiodic gap with 3 subframes from the current time. So USIM-A may generate the MUSIM gap request in the format of “MUSIMStart-SFN-AndSubframe” as 100, 8 to the network A, i.e., in accordance with the timing configuration of the primary cell of the network A.

Specifically, following changes may be made to TS38.331 for the above embodiments:

musim-GapRepetition AndOffset
Indicates the gap repetition period in ms and gap offset in number
of subframes forthe periodic MUSIM gap without leaving
RRC_CONNECTED state. Derived using the PCell of
RRC_CONNECTED UE.
musim-Start-SFN-AndSubframe
Indicates gap starting position for the aperiodic MUSIM gap without
leaving RRC_CONNECTED state. This field is only used for aperiodic
gap. Derived using the PCell of RRC_CONNECTED UE.

Further, at step 504, the process 500 may include receiving, by the USIM-A 104a, “MUSIMGapAssistanceConfig” information from the network-A. The MUSIMGapAssitanceConfig may correspond MUSIM timing configuration information which may be required to calculate the MUSIM gap, as discussed in method 200-400. At step 506, the RRC-Reconfiguration may be completed. At step 508, the USIM-B 104b may determine that the USIM-B 104b requires MUSIM gaps, for example, a periodic gap for network operations such as, but not limited to, paging monitoring, measurements, and so forth, at USIM-B 104b with an off-set: x-b and gap-length: gl-b every repetition period RP-b, and an aperiodic gap network operation such as, but not limited to, cell reselection etc. at USIM-B 104b with starting subframe SFN: x1-b,Subframe:y1-b and gaplength:gl1-b. Next, at step 510, the USIM-A 104a may convert the timing information of the USIM-B 104b based on timing configuration of PCell. Therefore, the step 510 may correspond to step 206, as shown in FIG. 2. Specifically, at step 510, the process 500 may include converting offset: x-b, SFN: x1-b,Subframe:y1-b into offset: x-PcellA, SFN: x1-Pcell-A,Subframe:y1-Pcell-A based on Pcell-A SFN and subframe timings. At step 512, USIM-A 104a may request MUSIM gap in MUSIMgapconfig request which may include offset: x-PcellA, SFN: x1-Pcell-A,Subframe:y1-Pcell-A as the requested offset and startingSFNandsubframe within preferred gapconfiguration, as calculated in previous step. The step 512 may also corresponds to steps 208-210 of the method 200. At step 514, the network A may transmit the RRC reconfiguration with MUSIM gap configured based on the transmitted request. At step 516, the RRC reconfiguration completes.

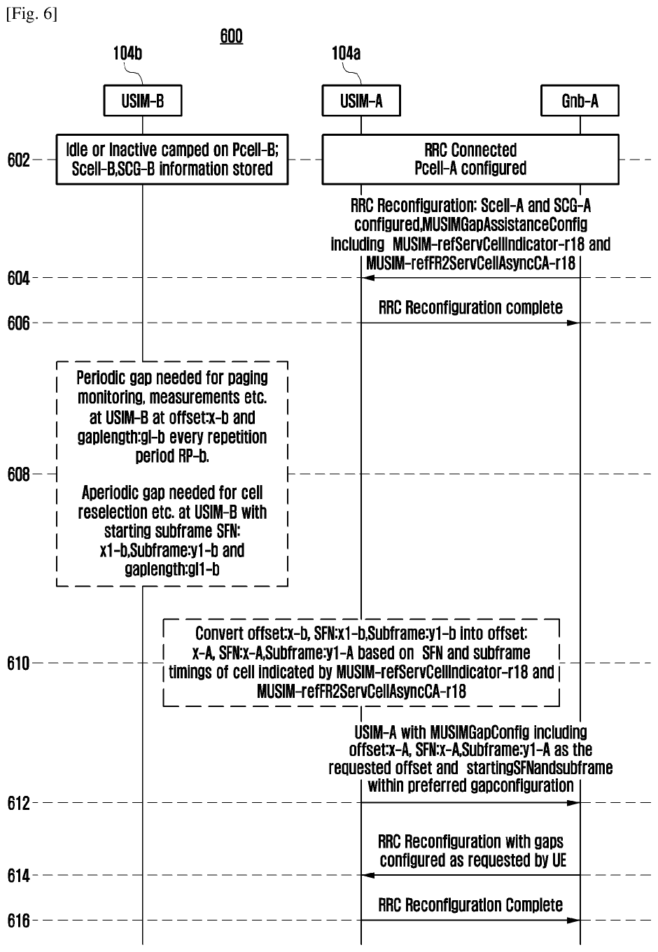

FIG. 6 illustrates an operational flow diagram depicting a process 600 for deriving System Frame Number (SFN)/subframe for the UE to request MUSIM gap when dual connectivity is configured, in accordance with an embodiment of the present subject matter. The process 600 may be implemented using the UE 102, components of the network-A, and/or components of network-B, as shown in FIG. 1.

In an embodiment, when USIM-A is configured with dual connectivity, the network A and/or the associated network component(s) may inform the USIM-A 104a regarding the cell that needs to be used for determining timing for requesting the SFN and subframe for aperiodic MUSIM gap (e.g. musim-Start-SFN-AndSubframe) and the gap offset for periodic MUSIM gap (e.g. offset within musimGapRepetitionAndOffset). In some embodiments, the network A and/or the associated network component(s) may request USIM-A 104b to use one of the PCell, PSCell or a FR2 cell in MCG configured in the USIM-A. In an exemplary embodiment, the USIMA 104a may request the MUSIM-Start-SFN-AndSubframe for aperiodic MUSIM gaps and the gap offset for periodic MUSIM gaps as per the timing configuration of the cell configured by the network A.

Further, embodiments explained above in reference to FIGS. 3-4 may be illustrated below. For example,
a current SFN and subframe number of Primary Cell (PCell) in USIM-A (PCell-A) may be 100 and 5,
a current SFN and subframe number of PSCell in USIM-A (PSCell-A) may be 100 and 7,
a current SFN and subframe number of Secondary cell (SCell) in MCG USIMA (SCellMCG-A) may be 98 and 3,
a current SFN and subframe number of Secondary cell (SCell) in SCG USIMA (SCellSCG-A) may be 108 and 1,
a current SFN and subframe number of camped cell in USIM-B (PCell-B) may be 75 and 4, and
a current SFN and subframe number of stored Scell in USIM-B (SCell-B) may be 78 and 3.

Further, the network A may configure the USIM-A 104a to requests the MUSIM gaps in reference to PScell. Let's assume, the USIM-B 104b may need an aperiodic gap with 3 subframes from the current time. So USIM-A 104a may generate the MUSIM gap request in the format of musim-Start-SFN-AndSubframe as 107,8 to the network A.

In an embodiment, if USIM-A is configured for requesting per-FR MUSIM gaps for FR2 gaps, the network A and/or associated network components may configure the UE 102 to use a particular FR2 cell as the reference for requesting the SFN and sub-frame for aperiodic MUSIM gap or offset for periodic MUSIM gap. NWK-A may provide the cell identifier of the FR2 cell to be used as reference, for MUSIM operations.

In alternative embodiment, if the network A and/or associated network component doesn't configure the cell to be used for requesting SFN and subframe for aperiodic MUSIM gaps and offset for periodic MUSIM gaps, the USIM-A 104a may use the PCell for the MUSIM gap request.

Specifically, following changes may be made to TS38.331 for the above embodiments:

OtherConfig-v17xy ::= SEQUENCE {
musim-GapAssistanceConfig-r17 SetupRelease {MUSIM-GapAssistanceConfig-
r17} OPTIONAL, - Need M
musim-LeaveAssistanceConfig-r17 SetupRelease {MUSIM-
LeaveAssistanceConfig-r17} OPTIONAL -- Need M
}
MUSIM-GapAssistanceConfig-r17 ::= SEQUENCE {
musim-GapProhibitTimer-r17 ENUMERATED {s0, sodot1, s0dot2, sodot3, s0dot4,
sodot5, s1, s2, s3, s4, s5, s6, s7, s8, s9, s10},
[[MUSIM-refServCellIndicator-r18 ENUMERATED
{pCell, pSCell, mcg-FR2}
OPTIONAL ]],
[[MUSIM-refFR2ServCellAsyncCA-r18 ServCellIndex OPTIONAL ]]
}

if the received otherConfig includes the musim-GapAssistanceConfig:
if musim-GapAssistanceConfig is set to setup:
consider itself to be configured to provide MUSIM assistance
information without leaving RRC_CONNECTED in accordance
with 5.7.4;
2>if MUSIM-refServCellIndicator-r18 is available
Calculate the gaps using the cell indicated by MUSIM-
refSerCellIndicator-r18.
3>If MUSIM-refServCellIndicator-r18 is mcg-FR2 and MUSIM-
refFR2ServCellAsyncCA-r18 is included, calculate the gaps using the
cell indicated by FR2 cell indicated by MUSIM-refFR2ServCellAsyncCA-
r18.

While the steps 602-616 are similar to steps 502-516, as explained in view of FIG. 5, at step 604, the network A may also transmit an indication of the reference cell to be used for calculation of timing requirement for the MUSIM gap. Further, at step 610, the USIM-A 104a may convert the MUSIM gap request by the USIM-B 104a based on the timing configuration of the cell indicated by the indication received at step 604. The description of the other steps has been omitted for the sake of brevity.

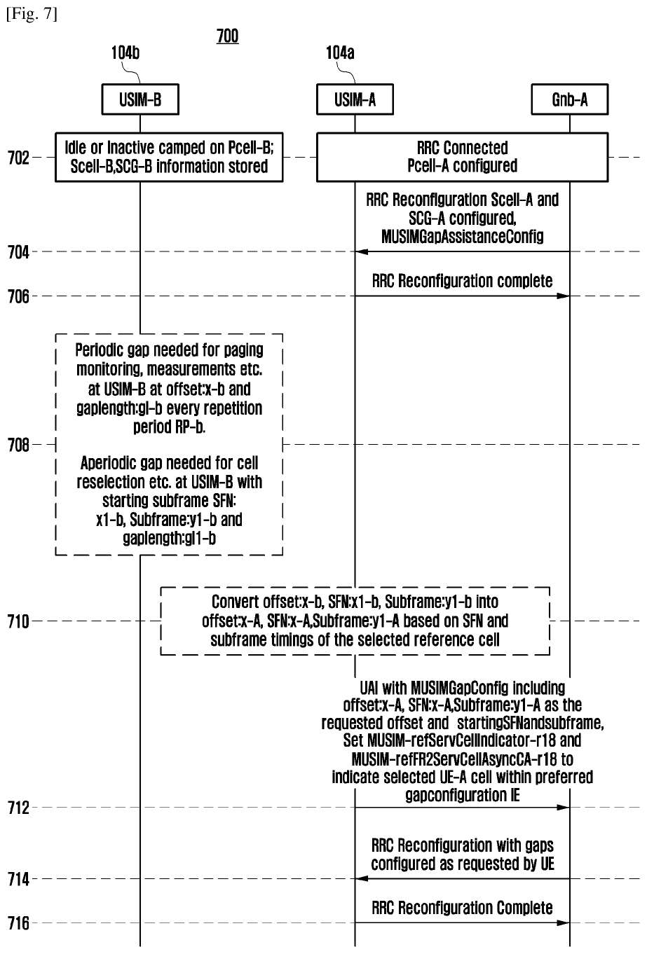

FIG. 7 illustrates an operational flow diagram depicting a process 700 for deriving System Frame Number (SFN)/subframe for the UE to request MUSIM gap when dual connectivity is configured, in accordance with another embodiment of the present subject matter. The process 700 may be implemented using the UE 102, components of the network-A, and/or components of network-B, as shown in FIG. 1.

In an embodiment, when USIM-A 104a is configured with dual connectivity, the USIM-A 104a may select the reference cell to be used for determining the timing for requesting the SFN and subframe for the aperiodic MUSIM gap (e.g. musimStart-SFN-AndSubframe) and the gap offset for the periodic MUSIM gap (e.g. offset within musim-GapRepetitionAndOffset) based on a pre-defined selection process. The USIM-A 104a may communicate the selected reference cell which may be used for determining the timing for requesting the MUSIM gaps to the network along with the start SFN and subframe for aperiodic MUSIM gaps and the offset for periodic MUSIM gaps in the MUSIM gap request. Particularly, the USIM-A 104a may indicate that one of the PCell, PSCell or a FR2 cell in MCG of USIM-A correspond to the reference cell used for the calculation of timing for MUSIM gap.

In an embodiment, if the USIM-A 104a is configured for requesting per-FR MUSIM gaps for FR2 gaps, the USIM-A 104a may decide to use a specific FR2 cell as the reference cell for determining the timing for requesting the starting SFN and sub-frame for aperiodic MUSIM gap or offset for periodic MUSIM gap based the pre-defined selection process. USIM-A may provide the cell identifier of the FR2 cell to be used as reference, for MUSIM operations. In such case, the USIM-A 104a also may indicate that the reference cell used is an FR2 cell in MCG of USIM-A 104a.

In an embodiment, if USIM-A 104a uses PCell for determining the timing for requesting the starting SFN and subframe for aperiodic MUSIM gaps and offset for periodic MUSIM gaps, it may not inform the cell used to the network A.

Further, embodiments explained above in reference to FIGS. 3-4 may be illustrated below. For example,
Current SFN/subframe of PCell in USIM-A (PCell-A): 100,5
Current SFN/subframe of PSCell in USIM-A (PSCell-A): 107,5
Current SFN/subframe of SCell in MCG USIM-A (SCellMCG-A): 98,3
Current SFN/subframe of SCell in SCG USIM-A (SCellSCG-A): 108,1
Current SFN/subframe of campedCell in USIM-B (PCell-B): 75,4
Current SFN/subframe of stored SCell in USIM-B (SCell-B): 78,3

The USIM-A 104a may select PCell to requests the MUSIM gaps based on the predefined selection process. In case, the USIM-B 104b may require an aperiodic gap with 3 subframes from the current time. The USIM-A 104a may request musimStart-SFN-AndSubframe as 100,8 in the requested gap information to the network A and communicate the selection of PCell to the network.

Specifically, following changes may be made to Example changes in TS38.331 for the above embodiment:

MUSIM-GapInfo-r17 ::= SEQUENCE {
musim-Starting-SFN-AndSubframe-r17 MUSIM-Starting-SFN-AndSubframe-r17
OPTIONAL,
musim-GapLength-r17 ENUMERATED {ms43, ms4, ms6, ms10, ms20},
musim-GapRepetition AndOffset-r17 CHOICE {
ms20-r17 INTEGER (0..19),
ms40-r17 INTEGER (0..39),
ms80-r17 INTEGER (0..79),
ms160-117 INTEGER (0..159),
ms320-r17 INTEGER (0..319),
ms640-r17 INTEGER (0..639),
ms1280-r17 INTEGER (0..1279),
ms2560-r17 INTEGER (0..2559),
ms5120-r17 INTEGER (0..5119),
} OPTIONAL
[[ MUSIM-refServCellIndicator-r18 ENUMERATED {pCell, pSCell, mcg-FR2}
OPTIONAL ]],
[[MUSIM-refFR2ServCellAsyncCA-r18 ServCellIndex OPTIONAL,]]
3

if transmission of the UEAssistanceInformation message is initiated to provide
MUSIM assistance information according to 5.7.4.2 or 5.3.5.3:
if the UE has a preference for MUSIM periodic gap(s):
include musim-GapPreferenceList, with an entry for each periodic gap the UE prefers
to be configured;
set musim-Gaplength and musim-GapRepetition AndOffset in the musim-GapInfo
IE to the values of the length and the repetition/offset of the gap(s), respectively, the
UE prefers to be configured with;
set MUSIM-refServCellIndicator-r18 to indicate the cell used for requesting the
MUSIM gaps if applicable.
If MUSIM-refServCellIndicator-r18 is set and is mcg-FR2
include MUSIM-refFR2ServCellAsyncCA-r18 to the cell id of the cell indicated by
FR2 cell used for requesting the MUSIM gaps.
2> if the UE has a preference for MUSIM aperiodic gap:
3> include the field musim-GapPreferenceList, with one entry for the aperiodic gap
the UE prefers to be configured;
set musim-Gaplength and musim-Starting-SFN-AndSubframe in the musim-
GapInfo IE to the values of respectively the length and the starting SFN/ subframe
of the gap, respectively, the UE prefers to be configured with;
set MUSIM-refServCellIndicator-r18 to indicate the cell used for requesting the
MUSIM gaps if applicable.
4>If MUSIM-refServCellIndicator-r18 is set and is mcg-FR2
include MUSIM-refFR2ServCellAsyncCA-r18 to the cell id of the cell indicated by
FR2 cell used for requesting the MUSIM gaps.
2> else (if the UE has no longer preference for the periodic/aperiodic gaps):
3>do not include musim-GapPreferenceList in the musim-Assistance IE;

In another embodiment, when the USIM-A 104a is configured with dual connectivity, the USIM-A 104a may request the starting SFN and subframes for aperiodic MUSIM gaps and the offset for periodic MUSIM gaps as per the SFN and subframe of the PCell in the USIM-A 104a.

In another embodiment, the USIM-A 104a may request and/or the network A may configure the USIM-A 104a with the MUSIM gaps applicable for one of MCG or SCG. If the USIM-A 104a is configured with MUSIM gap applicable for only one cell group, uplink or downlink data transfer may be implemented on the other cell group during gap duration.

In an embodiment, the USIM-A 104a may request and/or the network A may configure the USIM-A 104a with MUSIM gaps which are per-FR gaps. If the USIM-A 104a is configured with a per-FR MUSIM gap, during the MUSIM gap duration, data transfer may be restricted only to the serving cells belonging to the same FR as configured in the MUSIM gap.

While the steps 702-716, as shown in FIG. 7, are similar to steps 602-616 as explained in view of FIG. 6, at step 710 instead of converting the MUSIM timing requirement based on a reference cell indicated by the network A, the UE may converted the MUSIM timing requirement based on a cell selected using a pre-defined selection process, as also indicated by step 308 of the method 300.

In an embodiment, the network A and/or the network B as referred in above description may correspond to any suitable network devices which may be configured to implement the network A and/or the network B.

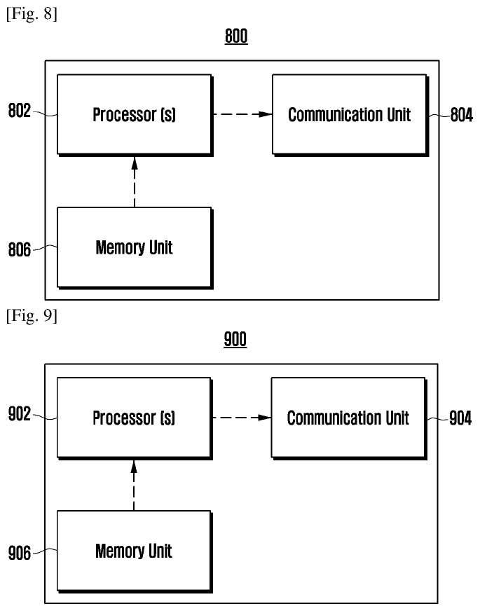

FIG. 8 is a diagram illustrating the configuration of a user equipment (UE) 800 in a wireless communication system, according to an embodiment of the present disclosure. The configuration of FIG. 8 may be understood as a part of the configuration of the UE 800. Further, the methods 200 and 300 as disclosed above may be implemented in the UE 800 according to a further embodiment. In an embodiment, the UE 800 corresponds to the UE 102. Hereinafter, it is understood that terms including “unit” or “module” at the end may refer to the unit for processing at least one function or operation and may be implemented in hardware, software, or a combination of hardware and software.

Referring to FIG. 8, the UE 800 may include at least one processor 802, a communication unit 804 (e.g., communicator or communication interface), and a storage unit 806 (e.g., storage). By way of example, the UE 800 may be a User Equipment, such as a cellular phone or other device that communicates over a plurality of cellular networks (such as a 3G, 4G, a 5G or pre-5G, 6G network or any future wireless communication network). The communication unit 804 may perform functions for transmitting and receiving signals via a wireless channel.

As an example, the processor 802 may be a single processing unit or a number of units, all of which could include multiple computing units. The processor 802 may be implemented as one or more microprocessors, microcomputers, microcontrollers, digital signal processors, central processing units, state machines, logic circuitries, and/or any devices that manipulate signals based on operational instructions. Among other capabilities, the processor 802 is configured to fetch and execute computer-readable instructions and data stored in the memory. The processor 802 may include one or a plurality of processors. At this time, one or a plurality of processors 802 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 802 may control the processing of the input data in accordance with a predefined operating rule or artificial intelligence (AI) model stored in the non-volatile memory and the volatile memory, i.e., memory unit 806. The predefined operating rule or artificial intelligence model is provided through training or learning.

The memory 806 may include any non-transitory computer-readable medium known in the art including, for example, volatile memory, such as Static Random Access Memory (SRAM) and Dynamic Random Access Memory (DRAM), and/or nonvolatile memory, such as Read-Only Memory (ROM), erasable programmable ROM, flash memories, hard disks, optical disks, and magnetic tapes.

FIG. 9 is a diagram illustrating the configuration of a base station 900 in a wireless communication system, according to an embodiment of the present disclosure. The configuration of FIG. 9 may be understood as a part of the configuration of the network-A and the network-B and/or associated component, particularly a base station. Further, the methods 400 as disclosed above may be implemented in the base station 900 according to a further embodiment. In an embodiment, the base station 900 corresponds to any of the gNB-MN, gNB-SN and so on. Hereinafter, it is understood that terms including “unit” or “module” at the end may refer to the unit for processing at least one function or operation and may be implemented in hardware, software, or a combination of hardware and software.

The components 902-906 are similar to components 802-806 and therefore the description of the same has been omitted for the sake of brevity.

In view of above embodiment, it is evident that the present disclosure enables implementation of MUSIM gaps in an effective and efficient manner and provides effective utilization of the network resources at a UE.

Some example embodiments disclosed herein may be implemented using processing circuitry. For example, some example embodiments disclosed herein may be implemented using at least one software program running on at least one hardware device and performing network management functions to control the elements.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1-15. (canceled)

16. A method performed by a terminal in a wireless communication system, the method comprising:
receiving, from a base station, a first message including information on a configuration for the terminal to report information for a gap preference;
transmitting, to the base station, a second message including information on a multi universal subscriber identity module (MUSIM) gap preferred by the terminal; and
receiving, from the base station, a third message including information for determining a system frame number (SFN) and a subframe associated with the MUSIM gap.

17. The method of claim 16,
wherein, in case that the MUSIM gap preferred by the terminal is periodic, the information on the MUSIM gap preferred by the terminal includes at least one of information on a length, information on a gap repetition period, or information on a gap offset.

18. The method of claim 16,
wherein, in case that the MUSIM gap preferred by the terminal is aperiodic, the information on the MUSIM gap preferred by the terminal includes at least one of information on a length, information on a starting SFN, or information on a starting subframe.

19. The method of claim 16,
wherein the SFN and the subframe are associated with a primary cell (PCell) of a master node (MN).

20. A method performed by a base station in a wireless communication system, the method comprising:
transmitting, to a terminal, a first message including information on a configuration for the terminal to report information for a gap preference;
receiving, from the terminal, a second message including information on a multi universal subscriber identity module (MUSIM) gap preferred by the terminal; and
transmitting, to the terminal, a third message including information for determining a system frame number (SFN) and a subframe associated with the MUSIM gap.

21. The method of claim 20,
wherein, in case that the MUSIM gap preferred by the terminal is periodic, the information on the MUSIM gap preferred by the terminal includes at least one of information on a length, information on a gap repetition period, or information on a gap offset.

22. The method of claim 20,
wherein, in case that the MUSIM gap preferred by the terminal is aperiodic, the information on the MUSIM gap preferred by the terminal includes at least one of information on a length, information on a starting SFN, or information on a starting subframe.

23. The method of claim 20,
wherein the SFN and the subframe are associated with a primary cell (PCell) of a master node (MN).

24. A terminal in a wireless communication system, the terminal comprising:
a transceiver; and
at least one processor coupled with the transceiver and configured to:
receive, from a base station, a first message including information on a configuration for the terminal to report information for a gap preference,
transmit, to the base station, a second message including information on a multi universal subscriber identity module (MUSIM) gap preferred by the terminal, and
receive, from the base station, a third message including information for determining a system frame number (SFN) and a subframe associated with the MUSIM gap.

25. The terminal of claim 24,
wherein, in case that the MUSIM gap preferred by the terminal is periodic, the information on the MUSIM gap preferred by the terminal includes at least one of information on a length, information on a gap repetition period, or information on a gap offset.

26. The terminal of claim 24,
wherein, in case that the MUSIM gap preferred by the terminal is aperiodic, the information on the MUSIM gap preferred by the terminal includes at least one of information on a length, information on a starting SFN, or information on a starting subframe.

27. The terminal of claim 24,
wherein the SFN and the subframe are associated with a primary cell (PCell) of a master node (MN).

28. A base station in a wireless communication system, the base station comprising:
a transceiver; and
at least one controller coupled with the transceiver and configured to:
transmit, to a terminal, a first message including information on a configuration for the terminal to report information for a gap preference,
receive, from the terminal, a second message including information on a multi universal subscriber identity module (MUSIM) gap preferred by the terminal, and
transmit, to the terminal, a third message including information for determining a system frame number (SFN) and a subframe associated with the MUSIM gap.

29. The base station of claim 28,
wherein, in case that the MUSIM gap preferred by the terminal is periodic, the information on the MUSIM gap preferred by the terminal includes at least one of information on a length, information on a gap repetition period, or information on a gap offset.

30. The base station of claim 28,
wherein, in case that the MUSIM gap preferred by the terminal is aperiodic, the information on the MUSIM gap preferred by the terminal includes at least one of the information on a length, information on a starting SFN, or information on a starting subframe.

31. The base station of claim 28,
wherein the SFN and the subframe are associated with a primary cell (PCell) of a master node (MN).
